(19) United States
(12) Patent Application Publication
(10) Pub. No.: US 2026/0320701 A1
(43) Pub. Date: Oct. 15, 2026

(54) EFFICIENT TAX ORGANIZER AND RETURN UPDATE SYSTEM USING LARGE LANGUAGE MODELS

(71) Applicant: INTUIT INC., Mountain View, CA (US)

(72) Inventors: John SAMUEL, Bangalore (IN); Gokul ELUMALAI, Bangalore (IN); Sanjay KUMAR, Bangalore (IN); Kritika SHARVA, Bangalore (IN); Srivathsal V, Bangalore (IN); Pradeep Kurunimakkil LXMINARAYANA, Bangalore (IN); Isham RAJGARIAH, Bangalore (IN); Sandeep MEWARA, Bangalore (IN); Vishal Kumar SINGH, Bangalore (IN); Pratul KUMAR JENA, Bangalore (IN); Anagha SUCHITRA, Bangalore (IN); Virendra VAISHNAV, Bangalore (IN); Kartik TRIPATHI, Bangalore (IN); Sahil Lokesh JAVERI, Bangalore (IN)

(73) Assignee: INTUIT INC., Mountain View, CA (US)

(21) Appl. No.: 19/179,830

(22) Filed: Apr. 15, 2025

(51) Int. Cl. G06Q 40/12

(52) U.S. Cl. CPC G06Q 40/123

(57) ABSTRACT

A system and method for efficient tax preparation using artificial intelligence. The method retrieves a user's prior year tax data, analyzes it with a machine learning model to identify changes in tax circumstances, and uses a large language model to generate personalized questions about those changes. After collecting user responses and documents, the system automatically updates the current year tax return and facilitates collaborative review between the taxpayer and tax preparer.

### BACKGROUND

Tax preparation systems have evolved over the years, incorporating digital technologies to streamline the process of collecting, organizing, and processing tax-related information. Modern tax preparation software typically includes features such as electronic filing, automated calculations, and basic questionnaires to guide users through the tax preparation process.

However, existing tax preparation systems often face limitations in their ability to adapt to individual taxpayer circumstances and changes in tax situations from year to year. Many systems rely on static questionnaires or rigid data collection methods that may not fully capture the nuances of a taxpayer's financial situation. This can lead to inefficiencies in the data collection process, potentially missing relevant information or requiring unnecessary input from users. The process of updating tax returns with new information can be time-consuming and prone to errors, particularly when dealing with complex tax scenarios or significant changes in a taxpayer's circumstances.

### SUMMARY

Embodiments disclosed herein solve the aforementioned technical problems and may provide other technical solutions as well. Contrary to conventional techniques, the disclosed solution includes a method and system for implementing an efficient tax organizer and return update system using large language models. The system analyzes prior year tax returns, generates personalized questionnaires, and updates current year returns with minimal manual intervention. This approach may streamline the tax preparation process, potentially improving accuracy and efficiency for both taxpayers and tax preparers.

An example embodiment includes a method for processing tax-related information, comprising retrieving, by a processor, prior year tax return data for a user, analyzing, by a machine learning (ML) model, in response to instructions from the processor, the prior year tax return data to identify changes in tax circumstances of the user, generating, by a large language model (LLM), a personalized questionnaire in context to the analyzed data from the ML model to request information on the identified changes in the tax circumstances of the user, collecting and processing, by the processor, documents and user input received in response to the personalized questionnaire, updating, by the processor, fields in a current year tax return corresponding to the collected and processed user inputs and documents, and facilitating, by the processor, collaborative review and finalization of the updated current year tax return.

An example embodiment includes a system for processing tax-related information, comprising, a database for storing tax return data, a machine learning (ML) model configured to, analyze a prior year tax return data to identify changes in tax circumstances of a user, a large language model (LLM) configured to generate a personalized questionnaire in context to the analyzed data from the ML model to request information on the identified changes in the tax circumstances of the user and a processor configured to collect and process documents and user input received in response to the personalized questionnaire, update fields in a current year tax return corresponding to the collected and processed user inputs and documents, and facilitate collaborative review and finalization of the updated current year tax return.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 illustrates a tax preparation system for processing tax-related information, according to aspects of the present disclosure.

FIG. 2 illustrates a tax processing system for processing tax-related data, according to an embodiment.

FIG. 3 is a flowchart of a method for processing tax returns using a tax preparation system, in accordance with example embodiments.

FIG. 4 is a flowchart of a method for user data collection and document processing in a tax preparation system, according to an aspect of the present disclosure.

FIG. 5 is a flowchart of a method for generating and refining tax-related questions using a LLM, according to aspects of the present disclosure.

FIG. 6 is a flowchart of a method for updating tax returns, according to an embodiment.

FIG. 7 is a flowchart of a method for collaborative tax return review, in accordance with example embodiments.

FIG. 8 illustrates a block diagram of a computing system, according to aspects of the present disclosure.

### DETAILED DESCRIPTION OF SEVERAL EMBODIMENTS

The present disclosure relates to systems and methods for efficient tax organizer and return update system using LLMs. This system may leverage advanced artificial intelligence techniques to analyze prior year tax returns, generate personalized questionnaires, and update current year tax returns with minimal manual intervention. By utilizing LLMs, the system may adapt to individual taxpayer circumstances, potentially improving accuracy and efficiency in tax preparation.

One of the key benefits of this system may be its ability to reduce the time and effort for both taxpayers and tax preparers. The system may automatically generate relevant questions based on historical data, potentially eliminating the need for taxpayers to navigate complex tax forms or redundant queries. For tax preparers, the system may streamline the data collection process and automate much of the return preparation, allowing them to focus on more complex tax issues and client advisory services.

In a real-world scenario, consider a small business owner who has been using the same tax preparation service for several years. In previous tax seasons, the small business owner spent hours gathering documents, filling out lengthy questionnaires, and meeting with her tax preparer to review details of her return. With the new system, the small business owner may receive a personalized questionnaire that focuses only on the areas of her tax situation that have changed from the previous year. The system may automatically populate much of her current year return based on prior year data and her responses to the tailored questions. The small business owner's tax preparer may then review the system-generated return, make any adjustments, and finalize the filing more efficiently than ever before.

The system may continuously learn and adapt over time, potentially improving its question generation and data interpretation capabilities. As the system processes more tax returns and collects more user responses, the system may refine its algorithms to generate increasingly accurate and relevant questions. This adaptive learning capability may lead to a more personalized and efficient tax preparation experience for each user over successive tax seasons.

The system may perform trend analysis across multiple users to identify emerging tax issues. By analyzing patterns in tax data from numerous taxpayers, the system may detect new deductions, credits, or compliance requirements that are becoming relevant to specific groups of taxpayers. This capability may allow tax preparers to proactively advise their clients on potential tax-saving opportunities or compliance obligations that they might otherwise overlook.

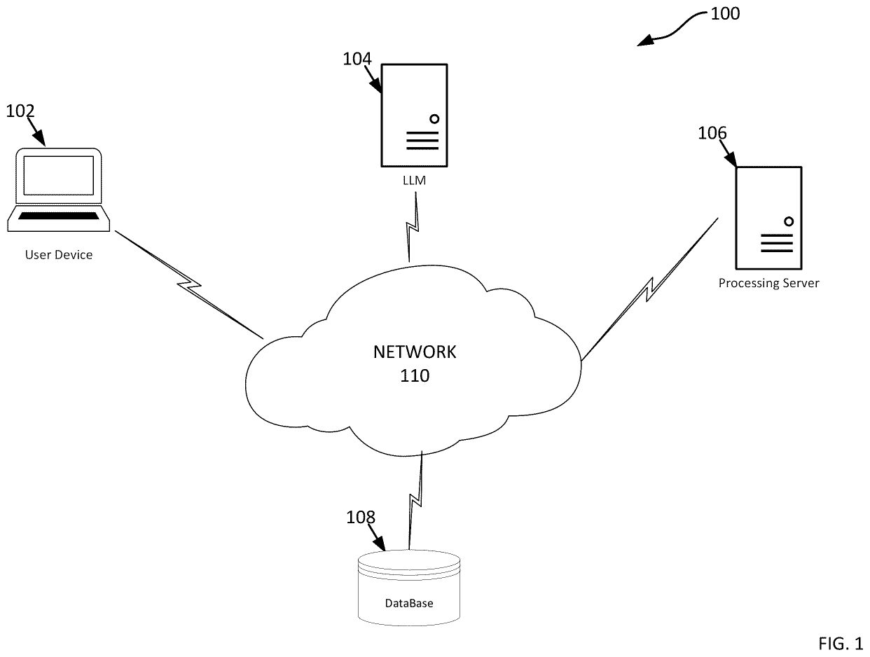

FIG. 1 illustrates a tax preparation system 100 for processing tax-related information. The tax preparation system 100 may include a client device 102, an LLM server 104, a processing server 106, a database 108, and a communication network 110.

In some cases, the client device 102 may be a personal computer, smartphone, tablet, or any other suitable computing device capable of connecting to the communication network 110. The client device 102 may allow users to input tax-related information and interact with the tax preparation system 100.

The LLM server 104 may be configured to analyze prior year tax return data and identify changes in tax circumstances of a user. In some cases, the LLM server 104 may utilize advanced natural language processing (NPL) techniques to interpret and process tax-related information. The LLM server 104 may be configured to generate a personalized questionnaire based on the analyzed data to request information on identified changes in tax circumstances.

In some implementations, the LLM server 104 may use Retrieval-Augmented Generation (RAG) and an embedded vector store to enhance question generation. The RAG technique may allow the LLM server 104 to retrieve relevant information from a knowledge base and incorporate it into the generated questions, improving the accuracy and relevance of the personalized questionnaire.

The processing server 106 may be responsible for handling various data processing tasks within the tax preparation system 100. In some cases, the processing server 106 may manage user interactions, coordinate data flow between different components of the system, and perform calculations for tax return preparation.

The database 108 may be used for storing tax return data. In some implementations, the database 108 may contain historical tax information, user profiles, and other relevant data for the operation of the tax preparation system 100. The database 108 may allow for efficient retrieval and storage of tax-related information, enabling the system to provide personalized and accurate tax preparation services.

The communication network 110 may facilitate data transmission between all connected components of the tax preparation system 100. In some cases, the communication network 110 may be the internet, a local area network (LAN), a wide area network (WAN), or any other suitable network infrastructure that enables secure and efficient data exchange between the system components.

In operation, a user may access the tax preparation system 100 through the client device 102. The client device 102 may send a request for tax preparation assistance to the processing server 106 via the communication network 110. The processing server 106 may then retrieve relevant user data from the database 108 and send the user data to the LLM server 104 for analysis.

The LLM server 104 may analyze the prior year tax return data, identify changes in the user's tax circumstances, and generate a personalized questionnaire. This questionnaire may be sent back to the client device 102 through the processing server 106 and communication network 110. The user may then provide responses and additional information through the client device 102.

As the user interacts with the system, the processing server 106 may continuously update the database 108 with new information. The LLM server 104 may refine its analysis and generate additional questions as needed, ensuring a comprehensive and accurate tax preparation process.

By leveraging the capabilities of each component, the tax preparation system 100 may provide a streamlined, personalized, and efficient tax preparation experience for users. The system's ability to analyze historical data, generate relevant questions, and adapt to changing tax circumstances may significantly enhance the accuracy and completeness of tax returns.

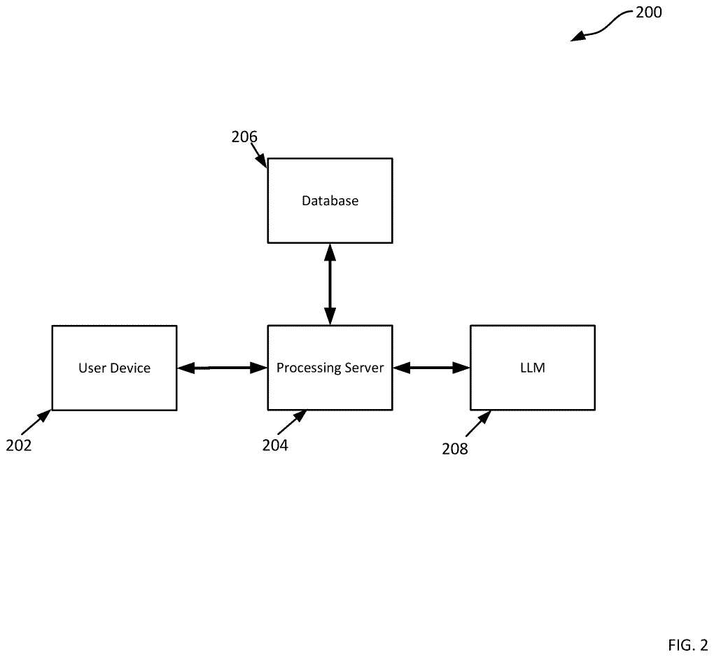

The tax processing system 200 shown in FIG. 2 may include a client device 202, a processing server 204, a database 206, and an LLM server 208. These components may work together to facilitate efficient tax preparation and processing.

The client device 202 may communicate with the processing server 204 to exchange tax-related information. For example, a taxpayer may use the client device 202 to input personal information, financial data, and answers to tax-related questions.

The processing server 204 may act as the central hub of the tax processing system 200, coordinating communication and data flow between the other components. In some cases, the processing server 204 may include tax document generation functionality to produce final tax documents. This functionality may allow the processing server 204 to compile the collected information into properly formatted tax returns and supporting documents.

The processing server 204 may also include document processing functionality to convert uploaded documents into structured data. For instance, if a taxpayer uploads a W-2 form through the client device 202, the processing server 204 may use optical character recognition (OCR) and data extraction techniques to convert the information from the image into a structured format that can be easily incorporated into the tax return.

The processing server 204 may also incorporate a machine learning (ML) model trained on historical tax data specific to the user, as well as historical LLM prompts and responses. This model may analyze the initial tax documents provided by the user to identify relevant data points and generate preliminary questions. The machine learning model may leverage patterns and insights from past tax filings and LLM interactions to determine which areas of the tax return may require further investigation or clarification. As described below, once the initial set of questions is generated, the LLM server 208 may refine and enhance these queries, potentially adding context, improving clarity, or generating follow-up questions based on its natural language processing capabilities. This two-step approach may combine the efficiency of machine learning in processing structured data with the nuanced understanding and question formulation abilities of the LLM, potentially resulting in a more comprehensive and tailored tax preparation experience for the user.

The database 206 may store various types of tax-related information, including historical tax data, current year inputs, and processed document information. In some cases, the database 206 may maintain a secure record of each taxpayer's information across multiple tax years, allowing for year-over-year comparisons and trend analysis.

The LLM server 208 may host one or more LLMs trained on tax-related data. These models may be used to analyze tax information, generate personalized questions, and assist in interpreting complex tax scenarios. For example, the LLM server 208 may analyze a taxpayer's historical data stored in the database 206 to identify potential changes in tax circumstances and generate relevant questions.

The LLM server 208 may receive the output from the ML model, which includes preliminary questions and identified data points from the user's tax documents. Using its extensive knowledge of tax regulations and contextual understanding, the LLM may then refine and enhance these initial queries. The LLM may analyze the preliminary questions, considering factors such as recent changes in tax laws, the specific circumstances of the taxpayer, and potential implications of the identified data points. Based on this analysis, the LLM may generate more nuanced and targeted questions, potentially adding context to complex tax concepts, improving the clarity of the queries, or creating follow-up questions to delve deeper into specific areas of the tax return. This process may result in a set of refined questions that are more relevant, comprehensive, and tailored to the individual taxpayer's situation, potentially improving the accuracy and completeness of the tax preparation process.

In some cases, the tax processing system 200 may include an organizer widget to display questions to users. This widget may be part of the user interface on the client device 202, presenting the personalized questions generated by the LLM server 208 in a user-friendly format. The organizer widget may adapt its questioning based on user responses, ensuring that relevant questions are asked.

The tax processing system 200 may also include a document widget to allow users to upload documents. This widget, which may be integrated into the client device 202 interface, may provide a simple way for taxpayers to submit supporting documentation such as receipts, forms, and financial statements. The uploaded documents may then be processed by the document processing functionality of the processing server 204.

The tax processing system 200 may include a review widget for accountants to review changes input by users. This widget may be accessed through a separate interface, possibly on a different client device, allowing tax professionals to review and verify the information submitted by taxpayers. The review widget may highlight changes from previous years, flag potential issues, and allow for direct communication with the taxpayer if clarification is needed.

The data flow within the tax processing system 200 may typically begin with the client device 202 sending user inputs and uploaded documents to the processing server 204. The processing server 204 may then communicate with the database 206 to store and retrieve relevant information. When complex analysis or question generation is needed, the processing server 204 may send requests to the LLM server 208. The results from the LLM server 208 may then be used by the processing server 204 to update the user interface on the client device 202 or to process tax returns. Throughout this process, the review widget may allow tax professionals to monitor and verify the information flow, ensuring accuracy and compliance with tax regulations.

In other words, the tax processing system employs a two-stage approach to data analysis and question generation. In the first stage, the ML model, integrated within the processing server, processes the initial tax documents and historical data. This ML model, trained on user-specific tax history and past interactions, efficiently handles structured data to identify relevant data points and generate a set of preliminary questions. The ML model's output includes both processed tax data and initial queries tailored to the user's tax situation. In the second stage, the output from the ML model is passed to the LLM hosted on the LLM server. The LLM, leveraging its advanced natural language processing capabilities, further refines and enhances the ML model's output. It analyzes the processed tax data and preliminary questions, considering factors such as recent changes in tax laws, the specific circumstances of the taxpayer, and potential implications of the identified data points. Based on this analysis, the LLM generates more nuanced and targeted questions, potentially adding context to complex tax concepts, improving the clarity of the queries, or creating follow-up questions to delve deeper into specific areas of the tax return. This sequential processing, where the ML model's output serves as input for the LLM, combines the efficiency of machine learning in handling structured data with the sophisticated language understanding and generation capabilities of the LLM, resulting in a more comprehensive and tailored tax preparation experience for the user.

This two-stage approach solves a technical problem in tax preparation systems by efficiently processing large volumes of structured tax data while also generating nuanced, context-aware questions. The ML model's ability to quickly analyze historical and current tax data addresses the challenge of handling complex, multi-year financial information. Meanwhile, the LLM's natural language processing capabilities solve the problem of generating personalized, relevant questions that adapt to individual tax situations. This combination overcomes the limitations of traditional rule-based systems, which struggle with the variability and complexity of individual tax scenarios. By integrating these technologies, the system provides a practical application that significantly improves the accuracy and efficiency of tax preparation, reducing the time and effort required by both taxpayers and tax professionals while potentially uncovering relevant tax considerations that might otherwise be overlooked.

It is noted that the tax processing system 200 may also incorporate technical solution of a feedback loop to continuously improve the ML model's performance. As users provide answers to the LLM-generated questions and tax preparers offer feedback on the generated tax returns, this valuable information may be used to refine and enhance the ML model. The system may collect and analyze user responses, noting which questions yielded the most relevant information and which may have been less effective. Similarly, feedback from tax preparers on the accuracy and completeness of the generated returns may be used to adjust the model's parameters. This collected data may be used to retrain the ML model periodically, potentially improving its ability to identify relevant data points, generate more accurate preliminary questions, and better predict areas of the tax return that require further investigation. By leveraging this user and expert feedback, the ML model may adapt over time to provide increasingly tailored and efficient tax preparation experiences, potentially reducing the need for manual intervention and improving the overall accuracy of the tax preparation process.

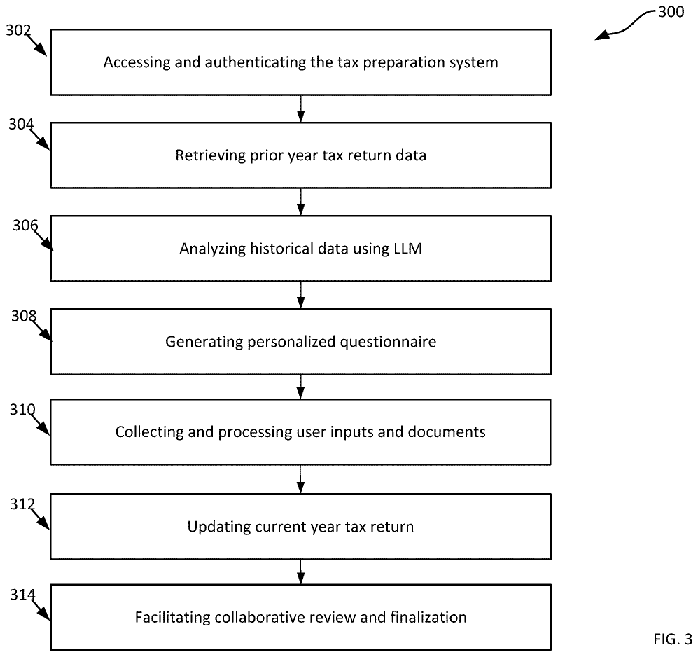

FIG. 3 illustrates a flowchart of a method 300 for processing tax returns using the tax preparation system 100. The method 300 for processing tax returns using the tax preparation system 100 may include steps performed by the system such as authenticating the system (step 302), retrieving prior year tax return data (step 304), analyzing historical data using LLM (step 306), generating a personalized questionnaire (step 308), collecting and processing user inputs and documents (step 310), updating the current year tax return (step 312), and facilitating collaborative review and finalization of the tax return (step 314). These steps represent a sequence of operations for efficiently processing tax-related information.

At 302, the system may may involve accessing and authenticating the tax preparation system 100. This may be performed by the client device 102, which may send authentication credentials to the processing server 106 via the communication network 110. The processing server 106 may verify the credentials against user information stored in the database 108. In some cases, the authentication process may involve multi-factor authentication to enhance security. The system may employ encryption algorithms such as AES-256 to protect sensitive data during transmission. The authentication process may include a time-based one-time password (TOTP) generator for an extra layer of security.

Once authenticated, the system may proceed to 304, which may involve retrieving prior year tax return data for a user. The processing server 106 may query the database 108 to fetch the relevant tax information. In some cases, the retrieved data may include not only the previous year's tax return but also historical data from multiple years to provide a comprehensive view of the user's tax history. The system may utilize advanced caching mechanisms to optimize data retrieval speed, potentially implementing a distributed cache system for improved performance. Furthermore, the data retrieval process may incorporate delta compression techniques to efficiently transfer the changes in tax data since the last retrieval, reducing bandwidth usage and improving response times.

At 306, the system may involve analyzing the historical data using the processing server 106. The processing server 106 may employ advanced ML model techniques to interpret the tax return data and identify changes in the user's tax circumstances. For example, the ML model may detect changes in income sources, marital status, dependents, or newly acquired assets that may impact the user's tax situation. The ML model may utilize transformer architecture with attention mechanisms to process and understand complex relationships within the tax data. The system may implement transfer learning techniques, allowing the ML model to leverage knowledge from pre-trained models on general tax domain data to enhance its performance on specific user tax scenarios.

At 308, the system may generate a personalized questionnaire based on the analyzed data output by the ML model. The LLM server 104 may create tailored questions to request information on the identified changes in the tax circumstances of the user. For instance, if the analysis detects a new dependent, the questionnaire may include specific questions about the dependent's information and potential tax credits or deductions associated with dependents. The question generation process may utilize a combination of rule-based systems and machine learning algorithms to ensure relevance and clarity. The system may also employ adaptive questioning techniques, where the order and content of questions dynamically adjust based on previous responses, optimizing the user experience and data collection efficiency.

At 310, the system may involve collecting and processing user inputs and documents. The client device 102 may present the personalized questionnaire to the user through a web interface. As the user provides responses and uploads relevant documents, the processing server 106 may validate the inputs in real-time and process the uploaded documents. This step may include OCR for extracting information from scanned documents and categorizing the extracted data into appropriate tax fields. The OCR process may utilize deep learning models, such as convolutional neural networks (CNNs), to improve accuracy in recognizing diverse document formats and handwriting styles. The system may implement natural language understanding (NLU) algorithms to interpret and extract relevant information from unstructured text in uploaded documents.

At 312, the system may update fields in the current year tax return. The processing server 106 may use the collected and processed user inputs and documents to populate the relevant fields in the tax return. This step may involve applying tax rules and calculations to ensure accurate reporting. For example, if the user reports a new source of income, the system may automatically calculate the tax implications and update the relevant schedules and forms accordingly. The tax calculation engine may utilize a combination of decision trees and expert systems to navigate complex tax regulations. Furthermore, the system may implement machine learning algorithms to detect potential errors or inconsistencies in the updated tax return, flagging these for review and potentially suggesting corrections.

At 314, the system may facilitate collaborative review and finalization of the updated current year tax return. The processing server 106 may notify a tax preparer about the completed user input and present the updated tax return for review. The tax preparer may use the client device 102 to access the return, review the changes, and make any adjustments. In some cases, this step may also involve communication between the tax preparer and the user to clarify any uncertainties or gather additional information before finalizing the return. The collaborative review process may be supported by a version control system, allowing multiple reviewers to work on the tax return simultaneously while tracking all changes. The system may implement AI-powered anomaly detection algorithms to highlight unusual patterns or discrepancies in the tax return for the tax preparer's attention, potentially improving the accuracy and completeness of the final return.

In the method of FIG. 3, various technical algorithms may be employed to enhance the tax preparation process. At 302, the system may utilize cryptographic hash functions like secure hash algorithm (SHA)-256 for secure authentication. At 304, distributed caching algorithms may be used for efficient data retrieval. Step 306 may leverage NPL algorithms like bidirectional encoder representations from transformers (BERT) or generative pretrained transformer (GPT) for analyzing historical tax data. For generating personalized questionnaires at 308, decision tree algorithms or reinforcement learning techniques may be applied. At 310, computer vision algorithms like you only look once (YOLO) or Mask R-CNN may be used for document processing and data extraction. At 312, the system may employ rule-based expert systems or fuzzy logic algorithms for tax calculations and field updates. At 314, collaborative filtering algorithms or graph-based recommendation systems may be used to facilitate the review process and suggest potential adjustments or optimizations to the tax return.

By following this method 300, the tax preparation system 100 may streamline the tax return process, leveraging the power of LLMs to provide a personalized and efficient experience for both users and tax preparers.

For the small business owner, the tax preparation process using the system illustrated in FIG. 3 may begin with her accessing and authenticating the tax preparation system through her client device (step 302). The system may then retrieve the small business owner's prior year tax return data (step 304) and analyze the tax return data using the LLM to identify changes in her business circumstances (step 306). Based on this analysis, the system may generate a personalized questionnaire for the small business owner, focusing on areas of her business that have changed since the previous year (step 308). As the small business owner responds to the questions and uploads relevant business documents, the system may collect and process this information (step 310), using the information to update her current year tax return (step 312). The system may facilitate a collaborative review process where the small business owner's tax preparer can examine the updated return, make any adjustments, and finalize the return with the small business owner's approval (step 314). This streamlined process may save the small business owner significant time and effort compared to her previous tax preparation experiences, while potentially improving the accuracy of her business tax return.

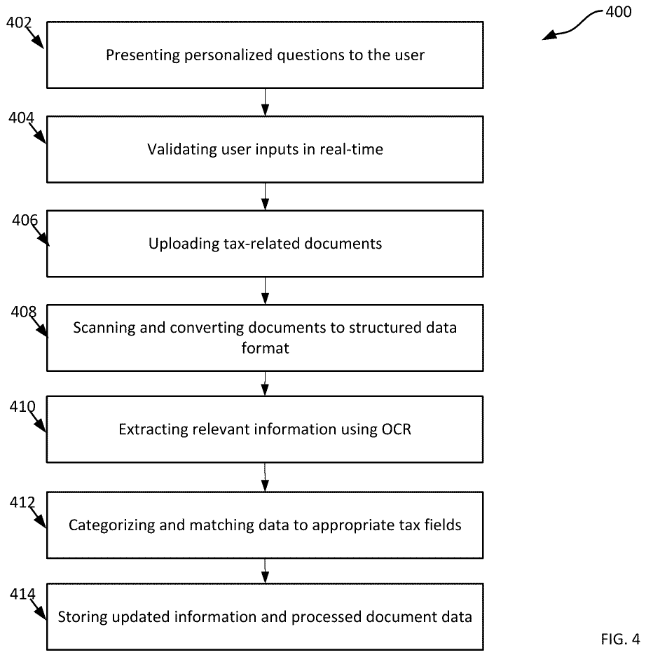

The tax preparation system 100 may include a method 400 for user data collection and document processing, as illustrated in FIG. 4. The method 400 for user data collection and document processing may include steps performed by the system such as presenting personalized questions to the user (step 402), validating user inputs in real-time (step 404), facilitating the uploading of tax-related documents (step 406), scanning and converting uploaded documents to structured data format (step 408), extracting relevant information using OCR (step 410), categorizing and matching extracted information to appropriate tax fields (step 412), and storing updated information and processed document data (step 414). These steps may work together to efficiently collect and process user data and documents for tax preparation purposes.

At 402, the LLM server 104 may present personalized questions to the user through a web interface on the client device 102. The web interface may be designed to be user-friendly and accessible, allowing taxpayers to easily navigate through the questionnaire. In some cases, the web interface may adapt its appearance based on the user's device, ensuring a consistent experience across desktop computers, tablets, and smartphones. The system may employ responsive design techniques, utilizing cascading style sheets (CSS) media queries and flexible grid layouts to dynamically adjust the interface elements based on screen size and resolution. The question presentation may utilize progressive disclosure techniques, revealing follow-up questions based on previous responses to minimize cognitive load on the user.

At 404, the processing server 106 may validate user inputs in real-time. This real-time validation may help prevent errors and inconsistencies in the submitted data. For example, if a user enters an invalid Social Security number format, the system may immediately flag the error and prompt the user to correct it. In some cases, the validation process may also cross-reference entered data with information from previous years to identify potential discrepancies. The system may implement client-side validation using JavaScript to provide immediate feedback without server requests, enhancing responsiveness. For more complex validations, the system may utilize AJAX calls to perform server-side checks asynchronously, ensuring data integrity without disrupting the user experience.

At 406, the processing server 106 may facilitate the uploading of tax-related documents. The system may provide a secure upload mechanism that allows users to submit various types of tax documents, such as W-2 forms, 1099 forms, and receipts for deductible expenses. In some cases, the system may provide guidance on which documents are needed based on the user's specific tax situation, as determined by the personalized questionnaire. The upload process may utilize chunked file transfer protocols to handle large documents efficiently, allowing for resumable uploads in case of connection interruptions. The system may implement server-side virus scanning and file type validation to ensure the security and integrity of uploaded documents.

At 408 the processing server 106 may scan and convert the uploaded tax-related documents to a structured data format. This conversion process may transform image-based documents into machine-readable text, allowing for easier data extraction and analysis. In some cases, the system may use advanced image processing techniques to enhance document quality before conversion, improving the accuracy of the subsequent data extraction. The system may employ adaptive thresholding algorithms to optimize image contrast and readability across various document types and qualities. Furthermore, the conversion process may utilize machine learning-based document classification to automatically categorize uploaded files, streamlining the organization of tax-related materials.

At 410, the processing server 106 may extract relevant information from the converted documents using OCR technology. The OCR process may identify and capture data points from the documents, such as income amounts, employer identification numbers, and dates. In some cases, the system may employ machine learning algorithms to improve OCR accuracy over time, learning from corrections made by users or tax professionals. The OCR engine may utilize CNNs for character recognition, improving accuracy for various font styles and handwritten text. Post-processing algorithms may be applied to correct common OCR errors, such as confusing similar characters, further enhancing extraction accuracy.

At 412, the processing server 106 may categorize and match the extracted information to appropriate tax fields. This step may ensure that the data from uploaded documents is correctly mapped to the relevant sections of the tax return. For example, information from a W-2 form may be automatically populated into the wage and salary income fields of the tax return. In some cases, the system may use contextual clues and pattern recognition to accurately categorize ambiguous data points. The categorization process may employ NPL techniques, such as named entity recognition and semantic analysis, to understand the context of extracted information. The system may utilize a knowledge graph representation of tax concepts to establish relationships between extracted data points and corresponding tax form fields.

At 414, the processing server 106 may store the updated information and processed document data in the database 108. This storage step may create a comprehensive record of the user's tax information, which can be used for future reference and year-over-year comparisons. In some cases, the system may implement data encryption and access controls to ensure the security and privacy of stored tax information. The database may utilize a sharding strategy to distribute large datasets across multiple servers, improving query performance and scalability. Furthermore, the system may implement a versioning mechanism to track changes in stored tax information over time, allowing for easy auditing and historical analysis of a user's tax situation.

In the steps of FIG. 4, various technical algorithms may be employed to enhance the user data collection and document processing. At 402, natural language generation algorithms like GPT-3 or T5 may be used to create personalized questions. At 404, regular expressions and fuzzy matching algorithms may be applied for real-time input validation. At 406, the system may utilize secure file transfer protocols such as secure file transfer protocol (SFTP) or hypertext transfer protocol secure (HTTPS) for document uploads. At 408, image preprocessing algorithms like Gaussian blur or histogram equalization may be used to enhance document quality before conversion. At 410, deep learning-based OCR models such as CRNN (Convolutional Recurrent Neural Network) or Tesseract may be employed for text extraction. At 412, the system may leverage named entity recognition algorithms for categorizing extracted information. At 414, data compression algorithms such as Huffman coding may be used for efficient storage, while encryption algorithms like advanced encryption standard (AES) or Rivest-Shamir-Adleman (RSA) may ensure data security.

The method 400 may streamline the tax preparation process by automating data collection and document processing. By leveraging advanced technologies such as OCR and real-time validation, the system may reduce errors and improve the accuracy of tax returns. The structured storage of processed data may facilitate easier retrieval and analysis in subsequent tax years, potentially simplifying the tax preparation process for returning users.

For the small business owner, the method 400 illustrated in FIG. 4 may streamline her tax preparation process significantly. The system may present the small business owner with personalized questions tailored to her business circumstances (step 402), validating her inputs in real-time to prevent errors (step 404). The small business owner may then upload her business-related tax documents, such as income statements, expense receipts, and asset purchase records (step 406). The system may scan and convert these documents into a structured format (step 408), using OCR technology to extract relevant information like revenue figures, expense amounts, and dates (step 410). This extracted data may be automatically categorized and matched to appropriate fields in the small business owner's tax return (step 412), such as business income, deductions, and depreciation schedules. The system may store all of the small business owner's updated information and processed document data securely (step 414), creating a comprehensive record of her business's tax information that can be easily referenced and compared in future tax years. This automated process may save the small business owner considerable time and effort in organizing her business tax documents, potentially reducing the likelihood of errors and ensuring a more accurate representation of her business's financial situation for tax purposes.

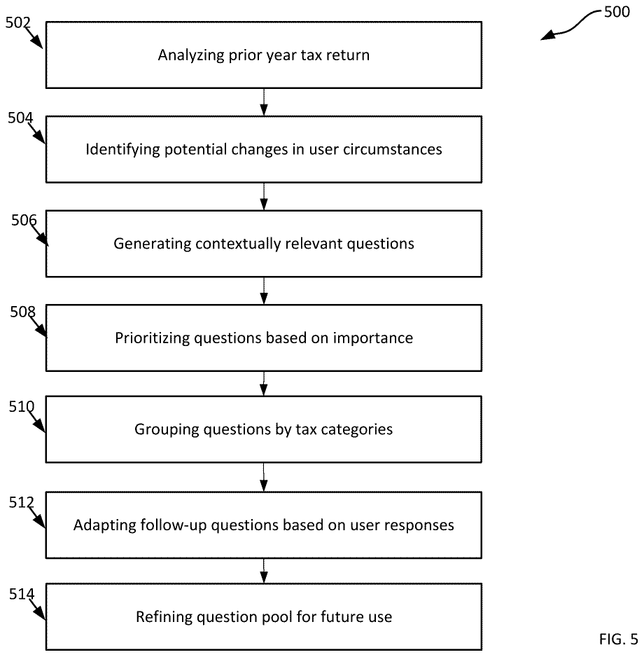

FIG. 5 illustrates a flowchart of a method 500 for generating and refining tax-related questions using a combination of the ML model and the LLM. The method 500 for generating and refining tax-related questions using may include steps performed by the system such as analyzing a prior year tax return (step 502), identifying potential changes in user circumstances (step 504), generating contextually relevant questions based on identified changes (step 506), prioritizing generated questions based on importance (step 508), grouping prioritized questions by tax categories (step 510), adapting follow-up questions based on user responses (step 512), and refining the question pool for future use (step 514). These steps represent a sequence of operations for efficiently generating and refining tax-related questions.

At 502, the system may involve analyzing a prior year tax return. The processing server 204 may process the tax return data retrieved from the database 206 using the ML model to identify fields and changes year-over-year. This analysis may include examining various sections of the tax return, such as income sources, deductions, credits, and personal information. For example, the ML model may detect changes in employment status, new dependents, or substantial fluctuations in income or expenses compared to previous years. The system may employ machine learning algorithms to identify patterns and anomalies in numerical data, potentially flagging unusual changes for further review.

Following the analysis, the system may proceed to 504, which may involve identifying potential changes in user circumstances. Based on the fields and changes identified at 502, the ML model may infer potential changes in the user's tax situation. For instance, if the analysis reveals a new dependent, the ML model may flag this as a potential change that may affect various tax credits and deductions. The inference process may utilize a knowledge graph representation of tax concepts to establish relationships between different data points. Furthermore, the system may implement a probabilistic model to assess the likelihood of various life events based on the observed changes in the tax return data.

At 506, the system may generate contextually relevant questions based on the identified changes. The ML model may output structured data and/or initial questions, and the LLM server 208 may use its NPL capabilities to formulate questions that are specific to the user's tax situation. For example, if a new dependent was identified, the LLM server 208 may generate questions about the dependent's relationship to the taxpayer, age, and whether they lived with the taxpayer for more than half the year. The question generation process may utilize a combination of template-based approaches and neural language models to create grammatically correct and contextually appropriate queries. The system may implement a semantic similarity algorithm to ensure that generated questions are not redundant with information already present in the tax return.

The system may then proceed to 508, which may involve prioritizing the generated questions based on importance. The LLM server 208 may assess the potential impact of each question on the user's tax liability or refund. Questions related to substantial changes or those that may affect the tax outcome may be given higher priority. For instance, questions about a new business venture may be prioritized over questions about minor changes in personal expenses. The prioritization algorithm may utilize a weighted scoring system that considers factors such as the monetary impact, legal requirements, and relevance to recent tax law changes. Furthermore, the system may employ a dynamic programming approach to optimize the order of questions for maximum information gain with minimal user effort.

At 510, the system may group the prioritized questions by tax categories. The LLM server 208 may organize the questions into logical categories such as income, deductions, credits, and personal information. This categorization may help create a structured and coherent questionnaire for the user. For example, all questions related to new dependents may be grouped under a “Dependents” category, while questions about new income sources may be grouped under an “Income” category. The categorization process may utilize unsupervised clustering algorithms to identify natural groupings among the generated questions. The system may implement a hierarchical taxonomy of tax concepts to ensure that the categorization aligns with standard tax return structures.

The system may continue at 512, which may involve adapting follow-up questions based on user responses to the personalized questionnaire. As the user provides answers through the client device 202, the LLM server 208 may dynamically generate additional questions or modify existing ones based on the responses. For instance, if a user indicates they started a home-based business, the LLM server 208 may generate follow-up questions about home office expenses, business-related travel, or equipment purchases. The adaptive questioning system may utilize a decision tree algorithm to navigate through different branches of inquiry based on user responses. Furthermore, the system may implement reinforcement learning techniques to optimize the question selection process over time, learning from the effectiveness of previous question sequences.

At 514, the system may refine the question pool for future use. The LLM server 208 may analyze the effectiveness of the questions based on user responses and tax preparer feedback. Questions that consistently provide valuable information may be retained and potentially prioritized in future questionnaires. Conversely, questions that often yield irrelevant or redundant information may be modified or removed from the pool. This continuous refinement process may help improve the efficiency and accuracy of the tax preparation system 100 over time. The refinement algorithm may utilize a combination of statistical analysis and machine learning techniques to evaluate question performance. The system may implement a version control mechanism to track changes in the question pool, allowing for rollback to previous versions if needed.

In the steps of FIG. 5, various technical algorithms may be employed to enhance the question generation and refinement process. At 502, NPL algorithms like BERT or XLNet may be used to analyze prior year tax returns. In step 504, knowledge graph algorithms such as TransE or RotatE may be applied to identify potential changes in user circumstances. At 506, the system may utilize sequence-to-sequence models like T5 or GPT for generating contextually relevant questions. For prioritizing questions at 508, multi-criteria decision-making algorithms such as Analytic Hierarchy Process (AHP) or technique for order of preference by similarity to ideal solution (TOPSIS) may be implemented. At 510, the system may leverage hierarchical clustering algorithms like balanced iterative reducing and clustering hierarchies (BIRCH) or ordering points to identify the clustering structure (OPTICS) for grouping questions by tax categories. At 512, reinforcement learning algorithms such as Q-learning or state action reward state action (SARSA) may be used to adapt follow-up questions based on user responses. At 514, ensemble learning techniques like Random Forest or Gradient Boosting may be employed to refine the question pool based on historical performance data.

By following this method 500, the tax preparation system 100 may generate highly relevant and personalized questions for each user, potentially improving the accuracy of tax returns and streamlining the data collection process. The adaptive nature of the question generation process may allow the system to evolve and improve with each tax season, providing an increasingly efficient experience for both taxpayers and tax preparers.

For the small business owner, the method 500 illustrated in FIG. 5 may significantly enhance her tax preparation experience. The ML model may analyze the small business owner's prior year tax return (step 502) to identify changes, such as her new business venture. The ML model may then identify potential changes in the small business owner's tax circumstances (step 504), such as new deductions or credits related to her small business. Based on these identified changes, the ML model in conjunction with the LLM may generate contextually relevant questions (step 506) specific to the small business owner's business situation, such as inquiries about business income, expenses, and asset purchases. These questions may be prioritized (step 508) based on their potential impact on the small business owner's tax liability, with business-related questions likely taking precedence. The system may then group these questions into relevant categories (step 510), such as “Business Income” or “Business Expenses.” As the small business owner responds to the initial questions, the system may adapt and generate follow-up questions (step 512) based on her answers, delving deeper into specific aspects of her business finances. The system may refine its question pool (step 514) based on the small business owner's responses and her tax preparer's feedback, improving its ability to generate relevant questions for small business owners in future tax seasons.

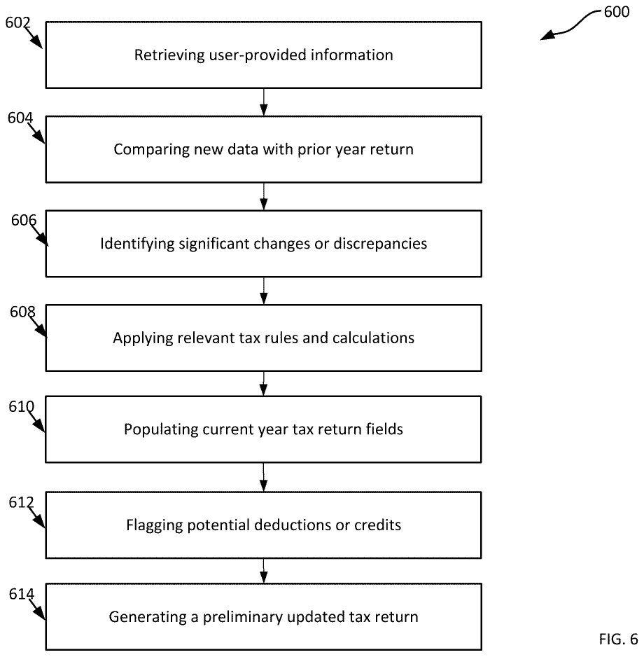

The tax preparation system 100 may include a method 600 for updating tax returns, as illustrated in FIG. 6. The method 600 for updating tax returns may include steps performed by the system such as retrieving user-provided information (step 602), comparing new data with prior year return information (step 604), identifying significant changes or discrepancies (step 606), applying relevant tax rules and calculations (step 608), populating current year tax return fields (step 610), flagging potential deductions or credits (step 612), and generating a preliminary updated tax return (step 614). These steps may work together to efficiently update tax returns based on new information provided by users.

At 602, the system may involve retrieving user-provided information. The processing server 106 may access the database 108 to fetch the most recent data submitted by the user through the client device 102. This data may include responses to the personalized questionnaire, uploaded documents, and any additional information provided during the tax preparation process. The processing server 106 may employ a distributed caching system to optimize data retrieval speed, potentially implementing techniques like Memcached or Redis for improved performance. The system may utilize delta compression algorithms to efficiently transfer the changes in tax data since the last retrieval, reducing bandwidth usage and improving response times.

At 604 of the system may involve comparing new data with prior year tax return data. The processing server 106 may analyze the retrieved information and compare the retrieved information with the tax return data from the previous year stored in the database 108. This comparison may help identify changes in the user's financial situation, such as new income sources, changes in marital status, or the addition of dependents. The processing server 106 may implement a diff algorithm, such as the Longest Common Subsequence (LCS) or Myers' algorithm, to efficiently detect differences between the current and prior year data. Furthermore, the system may utilize machine learning techniques, like decision trees or random forests, to classify and prioritize the identified changes based on their potential impact on the tax return.

At 606, the system may proceed to identify significant changes or discrepancies between the current and prior year data. The processing server 106 may employ algorithms to detect variations that exceed thresholds or that may have a substantial impact on the user's tax liability. For example, a significant increase in income, the sale of a property, or the start of a new business may be flagged as notable changes. The system may utilize statistical analysis techniques, such as z-score calculations or interquartile range (IQR) methods, to identify outliers and anomalies in the data. The processing server 106 may implement a rule-based expert system to evaluate the context and implications of detected changes, considering factors like tax law updates and industry-specific regulations.

At 608, the system may involve applying relevant tax rules and calculations to the identified changes. The processing server 106 may access a comprehensive database of tax regulations and apply the appropriate rules based on the user's specific situation. This may include calculating new tax brackets, determining eligibility for deductions or credits, and adjusting for any changes in tax laws that have occurred since the previous year. The system may employ a combination of decision trees and fuzzy logic to navigate complex tax regulations and handle scenarios with multiple possible interpretations. Furthermore, the processing server 106 may utilize parallel processing techniques to perform multiple tax calculations simultaneously, improving efficiency for users with complex tax situations.

At 610, the system may populate current year tax return fields with the processed information. The processing server 106 may automatically fill in the relevant sections of the tax return form with the updated data. This may include entering income figures, deductions, credits, and any other pertinent information derived from the user's inputs and the applied tax rules. The system may implement a template matching algorithm to ensure that data is correctly placed in the appropriate sections of the tax return, even if the form structure has changed from the previous year. The processing server 106 may use NPL techniques to interpret and categorize unstructured data from user inputs or documents, enabling more accurate population of tax return fields.

At 612, the system may involve flagging potential deductions or credits based on the analyzed data. The processing server 106 may review the user's information and identify opportunities for tax savings that the user may have overlooked. For example, the system may detect charitable contributions that qualify for deductions or expenses related to a home office that may be eligible for a business deduction. The processing server 106 may employ a recommendation system based on collaborative filtering techniques, analyzing patterns in tax data across multiple users to suggest potential deductions or credits. Furthermore, the system may utilize a knowledge graph representation of tax concepts to identify complex relationships between different aspects of the user's financial situation and applicable tax benefits.

At 614, the system may conclude with generating a preliminary updated tax return. The processing server 106 may compile all the processed information, calculations, and identified deductions or credits into a complete tax return document. This preliminary return may include all the needed forms and schedules based on the user's tax situation. The system may implement a document assembly algorithm that dynamically generates the tax return based on the specific components for the user's situation. The processing server 106 may utilize natural language generation techniques to create explanatory notes and summaries for complex calculations or unusual entries in the tax return, enhancing transparency and user understanding.

In the steps of FIG. 6, various technical algorithms may be employed to enhance the tax return update process. At 602, distributed caching algorithms like Memcached or Redis may be used for efficient data retrieval, while delta compression algorithms can optimize data transfer. At 604, diff algorithms such as the Longest Common Subsequence (LCS) or Myers' algorithm may be applied for comparing current and prior year data, alongside machine learning classifiers like decision trees or random forests. At 606, the system may utilize statistical analysis techniques such as z-score calculations or Interquartile Range (IQR) methods for anomaly detection, complemented by rule-based expert systems. At 608, decision trees and fuzzy logic algorithms may be implemented to navigate complex tax regulations, while parallel processing techniques can improve calculation efficiency. At 610, the system may employ template matching algorithms for accurate form population, along with NPL models for interpreting unstructured data. At 612, collaborative filtering algorithms and knowledge graph techniques may be used to identify potential deductions and credits. At 614, document assembly algorithms may be utilized to generate the preliminary tax return, supported by natural language generation models for creating explanatory notes and summaries.

By following this method 600, the tax preparation system 100 may provide users with an efficient and accurate way to update their tax returns. The system's ability to identify changes, apply relevant tax rules, and flag potential deductions may help users maximize their tax benefits while ensuring compliance with current tax regulations.

For the small business owner, the small business owner, the method 600 illustrated in FIG. 6 may streamline her tax return update process. The system may retrieve the small business owner's newly provided information about her business (step 602), comparing this information with her prior year's tax data (step 604) to identify significant changes, such as increased business income or new equipment purchases (step 606). The system may then apply relevant tax rules and calculations specific to small businesses (step 608), automatically populating the small business owner's current year tax return fields with the processed information (step 610). As the system analyzes the small business owner's data, the system may flag potential deductions or credits she may be eligible for as a small business owner, such as home office deductions or business travel expenses (step 612). The system may generate a preliminary updated tax return for the small business owner (step 614), incorporating all the processed information and identified tax-saving opportunities, which may provide her with a comprehensive view of her current tax situation before final review and submission.

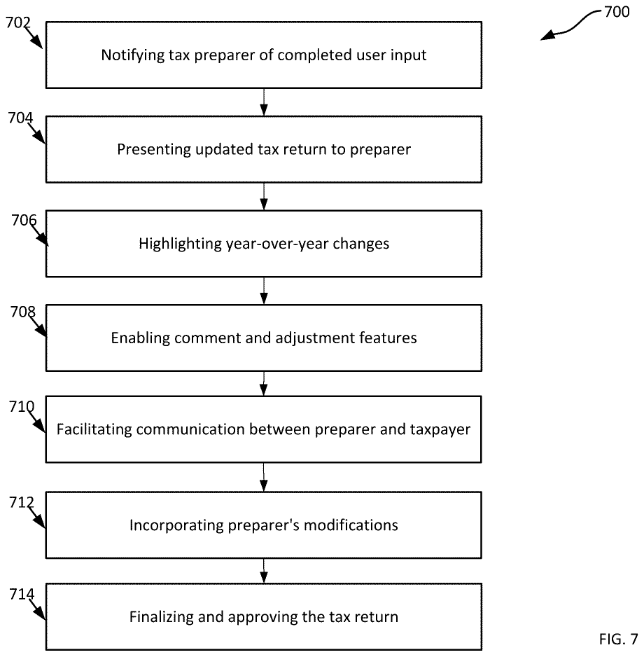

FIG. 7 illustrates a flowchart of a method 700 for collaborative tax return review. The method 700 for collaborative tax return review may include steps performed by the system such as notifying a tax preparer of completed user input (step 702), presenting an updated current year tax return to the preparer (step 704), highlighting year-over-year changes in the tax return (step 706), enabling comment and adjustment features for the tax preparer (step 708), facilitating communication between the preparer and taxpayer (step 710), incorporating the preparer's modifications to the tax return (step 712), and finalizing and approving the tax return (step 714). These steps represent a sequence of operations for efficiently reviewing and finalizing tax returns through collaboration between tax preparers and taxpayers.

At 702, the system may involve notifying a tax preparer of completed user input. The LLM server 208 may generate a notification message when a taxpayer has finished providing information through the personalized questionnaire. This notification may be sent to the tax preparer's client device 202, alerting them that a tax return is ready for review. The notification system may utilize a publish-subscribe messaging pattern, where the LLM server 208 acts as the publisher and the tax preparer's client device 202 as the subscriber. The system may implement a priority queue algorithm to ensure that high-priority notifications, such as those for complex tax situations or approaching deadlines, are delivered promptly.

At 704, the system may involve presenting an updated current year tax return to the preparer. The processing server 204 may compile the user-provided information, document data, and any automated calculations into a draft tax return. This draft may be displayed on the tax preparer's client device 202 through a secure interface. The system may employ a lazy loading technique to efficiently render large tax returns, loading the visible sections initially and fetching additional data as the user scrolls. Furthermore, the interface may utilize a responsive design framework, ensuring optimal display across various device types and screen sizes.

At 706, the system may proceed to highlight year-over-year changes in the tax return. The processing server 204 may analyze the current year's return against the previous year's data stored in the database 206. Significant changes, such as new income sources, altered filing status, or substantial differences in deductions, may be visually emphasized in the tax preparer's interface. The system may implement a diff algorithm, such as the Myers difference algorithm, to efficiently identify changes between the current and previous year's returns. The highlighting process may utilize machine learning techniques to adapt to each tax preparer's preferences, learning which types of changes they consider more relevant over time.

The processing server 204 may then enable comment and adjustment features for the tax preparer at 708. These features may allow the tax preparer to add notes, questions, or suggestions directly within the tax return interface. The comment system may implement a version control mechanism, similar to Git, allowing for tracking of changes and the ability to revert to previous versions if needed. Furthermore, the system may utilize NPL techniques to analyze comments and suggest relevant tax regulations or precedents that may apply to the discussed issues.

At 710, the system may involve facilitating communication between the preparer and taxpayer. The processing server 204 may provide a secure messaging system within the tax preparation interface, allowing the tax preparer to request additional information or clarification from the taxpayer. The messaging system may employ end-to-end encryption to ensure the confidentiality of sensitive tax information. The system may implement a chatbot powered by the LLM server 208 to handle routine queries, freeing up the tax preparer's time for more complex issues.

At 712, the system may incorporate the preparer's modifications to the tax return. As the tax preparer reviews and adjusts the return, the processing server 204 may update the tax return in real-time. These updates may be automatically saved and logged, creating an audit trail of changes. The system may utilize a conflict resolution algorithm to handle simultaneous edits by multiple users, ensuring data consistency. Furthermore, the processing server 204 may employ machine learning techniques to analyze patterns in the preparer's modifications, potentially automating common adjustments in future returns.

At 714, the system may involve finalizing and approving the tax return. Once the tax preparer has completed their review and made adjustments, the processing server 204 may generate a final version of the tax return. This version may include all modifications, supporting documentation, and any explanatory notes added during the review process. The system may implement a digital signature algorithm to securely capture the tax preparer's approval. The processing server 204 may utilize a compliance checking algorithm to ensure that the final return adheres to all relevant tax regulations before submission.

In the steps of FIG. 7, various technical algorithms may be employed to enhance the collaborative tax return review process. At 702, publish-subscribe messaging protocols like message queuing telemetry transport (MQTT) or Apache Kafka may be used for efficient notification delivery. At 704, lazy loading techniques and virtual scrolling algorithms may be implemented for rendering large tax returns. At 706, the system may utilize diff algorithms such as the Hunt-McIlroy algorithm or patience diff algorithm for identifying year-over-year changes. At 708, version control algorithms like merge algorithms or operational transformation may be used to manage comments and adjustments. At 710, the system may employ NPL algorithms like BERT or GPT for powering the chatbot and facilitating communication. At 712, conflict resolution algorithms such as operational transformation or differential synchronization may be used to handle simultaneous edits. At 714, digital signature algorithms like RSA or ECDSA may be implemented for secure approval, while rule-based compliance checking algorithms may ensure adherence to tax regulations.

By following this method 700, the tax preparation system 100 may streamline the collaborative review process between tax preparers and taxpayers. The system's ability to highlight changes, facilitate communication, and track modifications may enhance the accuracy and efficiency of tax return preparation, potentially reducing errors and improving client satisfaction.

For the small business owner, the collaborative tax return review process illustrated in FIG. 7 may significantly enhance her experience with the tax preparation system. The process may begin with the system notifying the small business owner's tax preparer that her input is complete (step 702). The preparer may then review the small business owner's updated tax return, which includes her new business information (step 704). The system may highlight year-over-year changes in the small business owner's return, such as her increased business income or new equipment purchases (step 706). The tax preparer may use the system's comment and adjustment features to ask questions or suggest modifications related to the small business owner's business expenses or deductions (step 708). The system may facilitate secure communication between the small business owner and her preparer, allowing them to discuss any complex aspects of her business taxes (step 710). As the preparer makes adjustments based on their expertise in small business taxation, the system may incorporate these changes in real-time (step 712). Once both the small business owner and her preparer are satisfied with the accuracy and completeness of the return, including all relevant business deductions and credits, they may finalize and approve the tax return for submission (step 714).

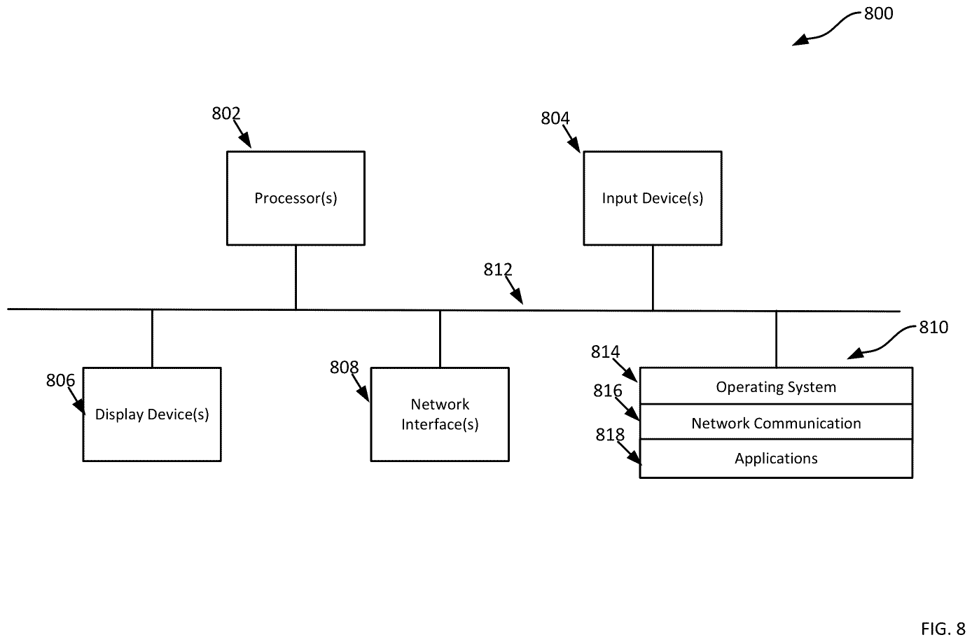

FIG. 8 illustrates a block diagram of a computing system 800 that may be used to implement the tax preparation system 100. The computing system 800 may include processor(s) 802, input device(s) 804, display device(s) 806, network interface(s) 808, and a software stack 810, all interconnected via a system bus 812.

The processor(s) 802 may be responsible for executing instructions and processing data within the computing system 800. In some cases, the processor(s) 802 may include multiple cores or processors to handle parallel processing and improve overall system performance. The processor(s) 802 may execute various components of the software stack 810 to perform the functions of the tax preparation system 100.

The input device(s) 804 may allow users to interact with the computing system 800. In some cases, the input device(s) 804 may include keyboards, mice, touchscreens, or voice recognition systems. For example, a taxpayer using the client device 102 may input their tax information through a touchscreen interface, which may be one of the input device(s) 804.

The display device(s) 806 may provide visual output for the computing system 800. In some cases, the display device(s) 806 may include monitors, touchscreens, or other types of visual displays. The display device(s) 806 may be used to present the personalized questionnaire generated by the ML model in conjunction with the LLM server 104 to the user, or to display the updated tax return for review.

The network interface(s) 808 may enable the computing system 800 to communicate with other devices and systems over a network. In some cases, the network interface(s) 808 may include Ethernet adapters, Wi-Fi modules, or cellular data modems. The network interface(s) 808 may facilitate communication between the various components of the tax preparation system 100, such as the client device 102, the LLM server 104, and the processing server 106.

The system bus 812 may provide a communication pathway between the various components of the computing system 800. In some cases, the system bus 812 may use different protocols or architectures depending on the specific requirements of the system.

The software stack 810 may include multiple layers of software that work together to provide the functionality of the tax preparation system 100. The software stack 810 may include an operating system layer 814, a communication layer 816, and an application layer 818.

The operating system layer 814 may manage hardware resources and provide basic system services. In some cases, the operating system layer 814 may handle tasks such as memory management, process scheduling, and device drivers. For example, the operating system layer 814 may manage the allocation of memory for storing tax return data or coordinate access to the input device(s) 804 and display device(s) 806.

The communication layer 816 may handle network communications through the network interface(s) 808. In some cases, the communication layer 816 may implement protocols such as TCP/IP, HTTP, or WebSocket to facilitate data exchange between different components of the tax preparation system 100. For instance, the communication layer 816 may manage the secure transmission of tax data between the client device 102 and the processing server 106.

The application layer 818 may contain the specific software applications and services that implement the functionality of the tax preparation system 100. In some cases, the application layer 818 may include components such as the tax return analysis module, the questionnaire generation module, and the tax return update module. For example, the application layer 818 may host the LLM used by the LLM server 104 to generate personalized questions based on the user's tax history.

In operation, the computing system 800 may work as follows: A user may input their tax information through the input device(s) 804, which may be processed by the application layer 818 running on the processor(s) 802. The application layer 818 may then use the communication layer 816 to send this data through the network interface(s) 808 to the processing server 106 for analysis by the ML model. The LLM server 104 may generate personalized questions based on the output of the ML model, which may be sent back to the computing system 800 and displayed to the user via the display device(s) 806. Throughout this process, the operating system layer 814 may manage system resources and ensure smooth operation of the hardware components.

The computing system 800 may provide the hardware and software infrastructure to support the complex operations of the tax preparation system 100. By integrating powerful processing capabilities, user interface components, network connectivity, and a layered software architecture, the computing system 800 may enable the efficient and accurate processing of tax information, generation of personalized questionnaires, and updating of tax returns.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method for processing tax-related information, comprising:
retrieving, by a processor, prior year tax return data for a user;
analyzing, by a machine learning (ML) model, in response to instructions from the processor, the prior year tax return data to identify changes in tax circumstances of the user and generate a set of preliminary questions;
passing the set of preliminary questions from the ML model to a large language model (LLM);
generating, by the LLM, a personalized questionnaire by refining and enhancing the preliminary questions from the ML model to request information on the identified changes in the tax circumstances of the user;
collecting and processing, by the processor, documents and user responses received in response to the personalized questionnaire;
updating, by the processor, fields in a current year tax return corresponding to the collected and processed user responses and documents;
facilitating, by the processor, collaborative review and finalization of the updated current year tax return; and
retraining the ML model based on the user responses to the personalized questionnaire and the updated current year tax return, wherein the retraining comprises adjusting parameters of the ML model to improve the ML model for generating preliminary questions for subsequent tax returns.

2. The method of claim 1, wherein analyzing the prior year tax return data comprises:
identifying, by the ML model, key fields and changes year-over-year in the prior year tax return data; and
generating, by the LLM, contextually relevant questions for the identified key fields and changes.

3. The method of claim 2, wherein generating the personalized questionnaire comprises:
prioritizing, by the LLM, the generated contextually relevant questions in order of importance; and
grouping, by the LLM, the prioritized questions by tax categories.

4. The method of claim 3, further comprising:
adapting, by the LLM, follow-up questions to user responses to the personalized questionnaire.

5. The method of claim 1, wherein collecting and processing user inputs and documents comprises:
presenting, by the LLM, the personalized questionnaire through a web interface;
validating, by the processor, user inputs in real-time; and
uploading, by the processor, tax-related documents.

6. The method of claim 5, further comprising:
scanning and converting, by the processor, the uploaded tax-related documents to a structured data format;
extracting, by the processor, relevant information from the converted documents using optical character recognition (OCR); and
categorizing and matching, by the processor, the extracted information to appropriate tax fields.

7. The method of claim 1, wherein updating the current year tax return comprises:
comparing, by the processor, new data with the prior year tax return data;
identifying, by the processor, significant changes or discrepancies between the current and prior year data;
applying, by the processor, relevant tax rules and calculations to the identified changes; and
populating, by the processor, current year tax return fields with the processed information.

8. The method of claim 7, further comprising:
flagging, by the processor, potential deductions or credits corresponding to the analyzed data.

9. The method of claim 1, wherein facilitating collaborative review and finalization comprises:
notifying, by the LLM, a tax preparer of completed user input;
presenting, by the processor, the updated current year tax return to the tax preparer;
highlighting, by the processor, year-over-year changes in the tax return; and
enabling, by the processor, comment and adjustment features for the tax preparer.

10. The method of claim 9, further comprising:
facilitating, by the processor, communication between the tax preparer and a taxpayer;
incorporating, by the processor, the user input to the tax return; and
finalizing, by the processor, and approving the tax return.

11. A system for processing tax-related information, comprising:
a database for storing tax return data;
a machine learning (ML) model configured to:
analyze a prior year tax return data to identify changes in tax circumstances of a user and generate a set of preliminary questions;
a large language model (LLM) configured to:
receive the set of preliminary questions from the ML model;
generate a personalized questionnaire by refining and enhancing the preliminary questions from the ML model to request information on the identified changes in the tax circumstances of the user; and
a processor configured to:
collect and process documents and user responses received in response to the personalized questionnaire,
update fields in a current year tax return corresponding to the collected and processed user responses and documents,
facilitate collaborative review and finalization of the updated current year tax return, and
retrain the ML model based on the user responses to the personalized questionnaire and the updated current year tax return, wherein the retraining comprises adjusting parameters of the ML model to improve the ML model for generating preliminary questions for subsequent tax returns.

12. The system of claim 11, wherein the ML model is configured to analyze the prior year tax return data by:
identifying key fields and changes year-over-year in the prior year tax return data; and
generating contextually relevant questions for the identified key fields and changes.

13. The system of claim 12, wherein the LLM is configured to generate the personalized questionnaire by:
prioritizing the generated contextually relevant questions in order of importance; and
grouping the prioritized questions by tax categories.

14. The system of claim 13, wherein the LLM is configured to adapt follow-up questions to user responses to the personalized questionnaire.

15. The system of claim 11,
wherein the LLM is configured to present the personalized questionnaire through a web interface;
wherein the processor is configured to:
validate user inputs in real-time, and
upload tax-related documents.

16. The system of claim 15, wherein the processor is configured to:
scan and convert the uploaded tax-related documents to a structured data format;
extract relevant information from the converted documents using optical character recognition (OCR); and
categorize and match the extracted information to appropriate tax fields.

17. The system of claim 11, wherein the processor is configured to update the current year tax return by:
comparing new data with the prior year tax return data;
identifying significant changes or discrepancies between the current and prior year data;
applying relevant tax rules and calculations to the identified changes; and
populating current year tax return fields with the processed information.

18. The system of claim 17, wherein the processor is configured to flag potential deductions or credits corresponding to the analyzed data.

19. The system of claim 11,
wherein the LLM is configured to notify a tax preparer of completed user input, wherein the processor is configured to:
present the updated current year tax return to the tax preparer,
highlight year-over-year changes in the tax return, and
enable comment and adjustment features for the tax preparer.

20. The system of claim 19,
wherein the processor is configured to:
facilitate communication between the tax preparer and a taxpayer,
incorporate the user input to the tax return, and
finalize and approve the tax return.
